(19) United States
(12) Patent Application Publication
(10) Pub. No.: US 2008/0042308 A1
(43) Pub. Date: Feb. 21, 2008

(54) Controlling Wall Thickness Uniformity in Divinyl Benzene Shells

(76) Inventor: Graham W. Flint, Albuquerque, NM (US)

Correspondence Address: NYDEGGER & ASSOCIATES, 348 OLIVE STREET, SAN DIEGO, CA, 92103, US

(21) Appl. No.: 11/465,092

(22) Filed: Aug. 16, 2006

(51) Int. Cl. B29C 67/00

(52) U.S. Cl. 264/15; 425/8

(57) ABSTRACT

A device is provided for establishing the uniformity of wall thickness for a plurality of hollow spherical shells suspended in a liquid. Specifically, the device imposes a variable angular acceleration on each shell in order to establish a uniform wall thickness for each shell. The device includes a container for receiving the liquid and the suspended shells. Further, the device includes a motor for moving the liquid to impose a variable angular acceleration on each shell. Also, the device includes an element for polymerizing each shell after each shell's wall thickness has become substantially uniform.

### FIELD OF THE INVENTION

The present invention pertains generally to devices and methods for forming hollow spherical shells for inertial fusion programs. More specifically, the present invention pertains to devices and methods for controlling the dimensions of the shells. The present invention is particularly, but not exclusively, useful as a device and method for controlling the uniformity of wall thickness for a plurality of hollow spherical shells formed with central cores.

### BACKGROUND OF THE INVENTION

Inertial fusion programs require spherical shell targets that have a precisely controlled wall thickness. Stated differently, there needs to be concentricity between the inner wall and outer wall of the shell. Heretofore, an approach for attaining the requisite wall thickness and concentricity has involved gently tumbling the shells in a fluid-filled container. While this approach has achieved modest success, it still does not achieve a uniformity for wall thickness that is always within the acceptable limits of ±1% variation. Specifically, the tumbling approach has resulted in a good sphericity for the shells, but there has been relatively poor uniformity in the wall thickness. For instance, typical variations in wall thickness are reported to be about ±5%, with values in the range of ±1% regime being rare.

With a review of some basic physical notions, it can be appreciated that in order to produce polymerized divinyl benzene (DVB) shells having a uniform wall thickness, forces must somehow be applied on the shells that will achieve this result. Preferably, these forces will be applied on the shell prior to (and during) the polymerization process. Importantly, if the shells are caused to move in a controlled manner, force(s) will act on the shells that are proportional to the acceleration of particles in the shell, and in the direction of the force(s). Stated differently, forces can be exerted on the shells in accordance with Newton's Second Law, F=ma.

With the above in mind, it is also to be appreciated that acceleration “a”is defined as the time rate of change of a particle's velocity “v”

$$( i . e . a = \frac{d v}{d t} ) .$$

Further, in vector notation, velocity has both a magnitude (speed) and a direction. Thus, an acceleration will result whenever either the magnitude, or the direction of the velocity of a particle is changed. In accordance with Newton's Second Law, (F=ma), whenever a non-zero resultant force acts on a particle, the particle will be accelerated. It follows that a particle experiences the application of a force whenever it is being accelerated (+a) or decelerated (−a).

In light of the above, it is an object of the present invention to provide a device and method for imposing forces (which, in turn, cause angular accelerations) on DVB shells to control the uniformity of their wall thickness. Another object of the invention is to provide a device and method for performing a large-scale production process which routinely provides a high yield of shells that exhibit wall thickness variations which are substantially less than +/−1%. Still another object of the invention is to provide a device and method for optimizing the motion of a shell-suspending fluid during the process of polymerizing the shells. Still another object of the invention is to provide a device and method for imposing a variable angular acceleration on each shell to establish a wall for each shell having a substantially uniform thickness. Yet another object of the present invention is to provide devices and methods for forming polymerized, hollow spherical shells that are easy to implement, simple to perform, and cost effective.

### SUMMARY OF THE INVENTION

In accordance with the present invention, a device is provided that will control the uniformity of the wall thickness that is established for hollow spherical shells, as the shells are formed during a polymerization process. Specifically, during the polymerization process, the device imposes a variable angular acceleration on each shell to establish the shell wall with a substantially uniform thickness. As envisioned for the present invention, the hollow spherical shells will initially be suspended in a liquid and held in a reservoir before they are polymerized. The shells then remain suspended in the liquid as they are transferred from the reservoir to a container. Once the liquid and shells are in the container, the container is then moved by a motor to impose the variable angular acceleration on the shells that is required to achieve substantial uniform wall thickness. After each shell's wall is established with a substantially uniform thickness, the shell is polymerized.

In one embodiment of the present invention, the container of the device is a tube that is formed with a lumen that defines a longitudinal axis. Preferably, the lumen has a radius that varies somewhat sinusoidally along its axial direction between a minimum radius of r₁ and a maximum radius of r₂. Thus, at each location where the radius is r₁, a bottleneck is formed in the tube. Between each pair of adjacent bottlenecks, there is a compartment. With this structure, a plurality of compartments are formed, and each compartment will have a substantially same predetermined volume. With this in mind, the device further comprises a pump or injector for sequentially introducing the liquid and suspended shells from the reservoir into the tube as a bolus having the same predetermined volume as each shell compartment.

For the operation of this embodiment of the present invention, the pump first introduces the liquid with suspended shells into the tube. The motor then rotates the tube about the tube's longitudinal axis to impose a variable angular acceleration on the shells in the lumen. Specifically, the tube is rotated with an angular velocity that is varied in a range between Ω₁ and Ω₂. Furthermore, Ω₁ will be greater than zero (0<Ω₁<Ω₂). Thus, as the motor increases and decreases the angular velocity of the tube within the range between Ω₁ and Ω₂, there are consequent changes in the direction of the angular acceleration “α” (i.e. ±α). For purposes of the present invention, these angular acceleration changes (±α) occur approximately every second or less. While the magnitude of the shells' angular velocity is varied, the direction of the shells' angular velocity is held constant. As a consequence, any forces arising from a density mismatch between the shells and their surrounding fluid are continuously changing in direction relative to each shell; the reason being that the effects of gravity on the shell are obviated and the core in the shell is centered.

In another embodiment of the present invention, the container of the device is a vessel for holding the liquid with the shells in the liquid suspended. For this embodiment, the vessel has an open end and a closed end, and the vessel defines a vessel axis that extends between these two ends. Further, this embodiment includes an arm having first and second ends. One end of the arm is attached to a pivot point and the arm extends from this pivot point to a distal end. The arm also defines a pivot axis that passes through the pivot point. The vessel is then positioned on the distal end of the arm, with the vessel axis distanced from, and parallel to, the pivot axis.

During operation of this embodiment of the present invention, a batch of the shells is delivered into the vessel, through its open end, with the shells suspended in the liquid. The vessel is then rotated about the vessel axis with an angular velocity (+Ω). At the same time, the arm is rotated about the arm's pivot axis in an opposite direction, but with a substantially same angular velocity (−Ω). As a result of the rotation of the vessel about the vessel axis, and the simultaneous rotation of the vessel axis about the pivot arm axis, the motor continuously varies the direction of motion of the suspending fluid relative to the shells. More importantly, velocity gradients within the fluid surrounding each shell impose a variable angular acceleration on the shells. Specifically, this variable angular acceleration results because, although the magnitude of the shells' angular velocity is held constant, the direction of their angular velocity vectors is continuously changing.

In each embodiment of the present invention, the variable acceleration is imposed on the shells to center each shell's core. The force responsible for centration arises as a consequence of the transfer of angular momentum from the outer surface of a shell to its inner surface. The result is to make each shell's wall thickness substantially uniform. Once the uniform wall thicknesses are established, the element for polymerizing each shell is activated to heat or otherwise fix each shell's wall. For the tube embodiment, the polymerizing action may be sequentially administered on shells at a downstream position in the tube. For the vessel embodiment, polymerization is typically accomplished as a batch process in which all shells in the vessel are polymerized at the same time, after uniform wall thicknesses are established.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic drawing of an embodiment of a continuous process device for controlling the uniformity of wall thickness for hollow spherical shells in accordance with the present invention;

FIG. 2 is a cross sectional view of the tube shown in FIG. 1, with the cross section passing through the axis of the tube;

FIG. 3 is a schematic drawing of an embodiment of a batch process device for controlling the uniformity of wall thickness for hollow spherical shells in accordance with the present invention; and

FIG. 4 is an overhead view of the device shown in FIG. 3, depicting sequential positions of the vessel in phantom.

### DESCRIPTION OF THE PREFERRED EMBODIMENTS

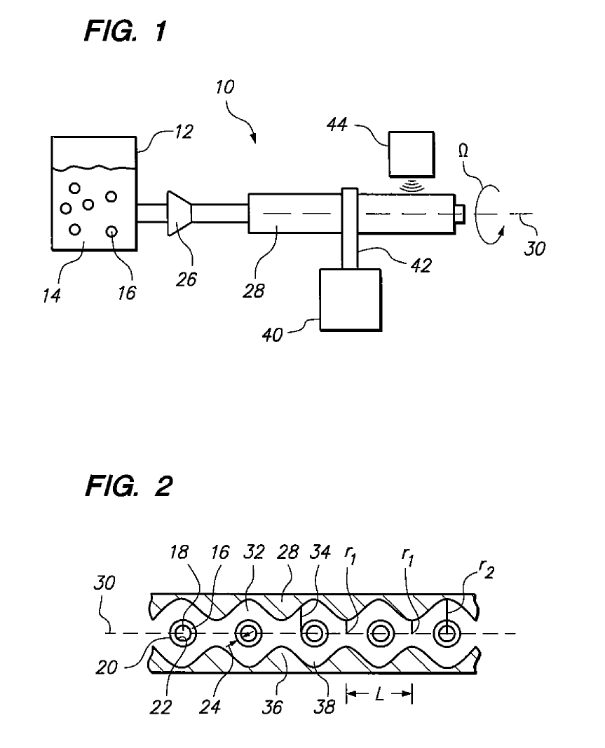

Referring initially to FIG. 1, a device for controlling the uniformity of wall thickness for hollow spherical shells is shown, and is generally designated 10. As shown in FIG. 1, the device 10 includes a reservoir 12 in which a liquid 14 is held. For purposes of the present invention, the hollow spherical shells 16 are suspended in the liquid 14 within the reservoir 12. Preferably, the liquid 14 is viscous, non-miscible, and has a specific gravity which is substantially identical to that of the shells 16. Further, the shells 16 are preferably formed from divinyl benzene (DVB). Referring briefly to FIG. 2, it can be seen that each shell 16 is substantially hollow and includes a core 18. As a result, each shell 16 has an outer surface 20 and an inner surface 22 that defines each shell's thickness 24. For purposes of the present invention, the shells 16 can be manufactured in any manner well known in the pertinent art, such as by an extruding process.

As shown in FIG. 1, the device 10 further includes a pump or injection device 26 that is in fluid communication with the reservoir 12. Further, the device 10 includes a tube 28 that is connected downstream of the reservoir 12 for receiving the liquid 14 and shells 16 from the pump 26. For purposes of the present invention, the tube 28 is substantially cylindrical and defines a longitudinal axis 30. As shown in FIG. 2, the tube 28 includes a lumen 32 that has a periodically (e.g. sinusoidally) varying radius 34. Specifically, the radius 34 of the lumen 32 varies between a minimum radius of r₁ and a maximum radius of r₂. As a result, the tube 28 forms a plurality of bottlenecks 36 at positions where the radius 34 is r₁. As shown, each bottleneck 36 is distanced from the adjacent bottleneck 36 by a length, L. As further shown, each pair of adjacent bottlenecks 36 bounds a shell compartment 38 such that all shell compartments 38 have the substantially same volume.

Referring back to FIG. 1, the device 10 also includes a motor 40 that is connected to the tube 28 via a drive belt or coupling 42. As a result, the motor 40 is able to rotate the tube 28 about the tube's longitudinal axis 30 with an angular velocity Ω. As further shown, the device 10 includes a heater or other polymerizing unit 44 such as a polymerization agent injector. For purposes of the present invention, the polymerizing unit 44 is provided to solidify or set each shell 16 after a uniform wall thickness 24 has been attained.

During operation of the device 10 shown in FIGS. 1 and 2, the shells 16 are first suspended in the liquid 14 and are stored in the reservoir 12. Because the shells 16 and the liquid 14 have the same specific gravity, the shells 16 may be suspended in the liquid 14 by merely mixing the two components. Thereafter, the pump 26 sequentially injects volumes of liquid 14 with shells 16 into the tube 28. Preferably, the pump 26 sequentially injects a bolus of the liquid 14 containing one shell 16. As envisioned for the present invention, this bolus will have substantially the same volume as each shell compartment 38. As a result, one shell 16 is positioned within each shell compartment 38 during operation of the device 10.

As the liquid 14 and shells 16 are received within the tube 28, the motor 40 rotates the tube 28 about the tube's longitudinal axis 30. Specifically, for this rotation, the motor 40 selectively varies the angular velocity of the tube 28 in a range between Ω₁ and Ω₂. More specifically, the angular velocity Ω₁ is greater than zero, and the angular velocity Ω₂ is greater than Ω₁. Thus, as the motor 40 changes the magnitude of the angular velocity of the tube 28 (i.e. the rotation velocity Ω of the tube 28 increases or decreases) the angular acceleration periodically reverses direction. Preferably, the cycle of “speed-up” and “slow-down” is done approximately once per second or faster. As the tube 28 is rotated, shear forces between the tube 28 and concentric layers of the liquid 14 are translated inward through the liquid 14 to the shells 16. As a result of the variable angular acceleration imposed on the shells 16, the shells 16 are centered on the longitudinal axis 30, and the cores 18 are centered within the shells 16. While the magnitude of the shells' angular velocity is varied, the direction of the shells' angular velocity is held constant to obviate the effects of gravity on the shell 16 as the core 18 in the shell 16 is centered. A further effect of varying the angular velocity of the tube is to cause each shell to become centered longitudinally within its shell compartment 38 during the time intervals between successive injections by the pump 26.

The process of intermittently centering the shells 16 on the longitudinal axis 30 and continuously centering the cores 18 within the shells 16 occurs as the shells 16 move downstream from shell compartment 38 to shell compartment 38. Once the wall thickness 24 of a shell 16 is sufficiently uniform, the shell 16 is polymerized by the application of heat or a polymerization agent from the polymerizing unit 44. Thereafter, the shell 16 is ejected from the tube 28.

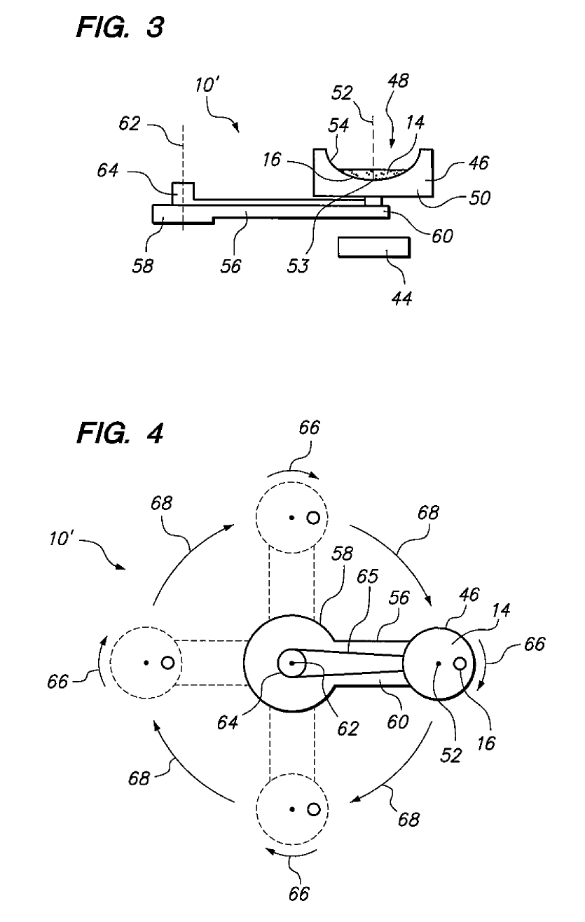

Turning now to FIG. 3, another embodiment of the device is illustrated and is generally designated 10′. In this embodiment, the device 10′ includes a vessel 46 which holds a batch of the shells 16 suspended in the liquid 14. As shown, the vessel 46 includes an open end 48 and a closed end 50 and defines a vessel axis 52 that extends between the ends 48, 50. Further, the vessel 46 includes an interior wall 54 that extends between the open end 48 and a point 53 on the vessel axis 52 at the closed end 50 of the vessel 46. Preferably, the interior wall 54 of the vessel 46 is defined by a decreasing radius of curvature in a direction from the point 53 at the closed end 50 to the open end 48.

Still referring to FIG. 3, the device 10′ further includes a pivot arm 56. As shown, the pivot arm 56 extends from a proximal end 58 to a distal end 60. The proximal end 58 defines a pivot axis 62 about which the arm 56 may be rotated. For purposes of the present invention, the vessel 46 is mounted at the distal end 60 of the pivot arm 56 for rotation about the vessel axis 52. As shown, the pivot axis 62 is distanced from the vessel axis 52 and is substantially parallel to the vessel axis 52. As a result of this arrangement, the vessel 46 may be rotated about the vessel axis 52 while, simultaneously, the vessel axis 52 is rotated about the pivot axis 62.

For purposes of the present invention, the device 10′ further includes a motor 64 for rotating the vessel 46 about the vessel axis 52. The motor 64 can also be used for pivoting the arm 56 about the pivot axis 62 such that the vessel axis 52 rotates about the pivot axis 62. In addition to the above disclosed structure, the device 10′ includes a polymerization unit 44 such as a heater or a polymerization agent injector to polymerize the shells 16 after their wall thickness has become substantially uniform.

Referring now to FIG. 4, the operation of the device 10′ of FIG. 3 is depicted. In FIG. 4, the shells 16 are suspended in the liquid 14 and held in the vessel 46. The motor 64 is connected via a drive belt 65 to rotate the vessel 46 about the vessel axis 52 in a direction 66 (illustrated as being counterclockwise). This rotation is with a substantially constant angular velocity +Ω. At the same time, the motor 64 pivots the arm 56 such that the vessel axis 52 rotates about the arm's pivot axis 62 in an opposite direction 68 (illustrated as being clockwise). Importantly, this counter-rotation is done with a substantially constant angular velocity −Ω. As a result of the rotation of the vessel 46 about the vessel axis 52 (+Ω) and the counter-rotation of the vessel axis 52 about the pivot arm axis 62 (−Ω), the shells 16 are enveloped in a suspending liquid 14 wherein the liquid's angular velocity varies as a function of depth beneath its surface. This, in turn, causes each shell 16 to experience a constantly varying angular acceleration. Specifically, this varying angular acceleration results because, the magnitude of the shells' angular velocity is held constant while the direction of their angular velocity is continually varied. As a result of the variable angular acceleration imposed on each shell 16, the core 18 in each shell 16 experiences a force which drives the core 18 toward the center of the shell 16, thereby creating a situation wherein the shell's wall thickness 24 becomes substantially uniform. Once each shell 16 attains a sufficiently uniform wall thickness 24, the polymerizing unit 44 (shown in FIG. 3) polymerizes the shells 16 through the application of heat or by adding a polymerizing agent to the liquid 14. After the shells 16 are polymerized, they may be removed from the vessel 46 and the process repeated for another batch of shells 16.

While the particular Controlling Wall Thickness Uniformity in Divinyl Benzene Shells as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for controlling the uniformity of wall thickness for a plurality of hollow spherical shells having central cores which comprises:
a means for suspending each shell in a liquid; and
a means for moving the liquid to impose a variable angular acceleration on each shell, and to obviate the decentering effects of gravity as the core in each shell is centered to establish a wall for the shell having a substantially uniform thickness.

2. A device as recited in claim 1 wherein the moving means comprises:
a tube defining a longitudinal axis, the tube being formed with a lumen for receiving the liquid with shells suspended therein; and
a motor for selectively varying the angular velocity of the tube in rotation about the axis to impose the variable angular acceleration upon the shells suspended within the liquid.

3. A device as recited in claim 2 wherein the angular velocity of the tube is selectively varied between an angular velocity Ω₂, and an angular velocity Ω₂, and wherein Ω₁ is greater than zero and less than Ω₂(0<Ω₁<Ω₂).

4. A device as recited in claim 3 wherein the direction of the angular acceleration is changed within approximately every second.

5. A device as recited in claim 2 wherein the lumen defines a radius that varies periodically along the axial direction between a minimum radius r₁ and a maximum radius r₂, with 0<r₁<r₂, and wherein the tube forms a plurality of bottlenecks when the radius is r₁, and further wherein the lumen forms a plurality of shell compartments, with each shell compartment being bounded by adjacent bottlenecks and having an axial length.

6. A device as recited in claim 5 wherein each shell compartment defines a substantially same predetermined volume in the lumen of the tube, and wherein the device further comprises a means for sequentially introducing the liquid with a single suspended shell, into the tube, as a bolus of the predetermined volume.

7. A device as recited in claim 6 further comprising a means for polymerizing each shell at a predetermined region along the tube.

8. A device as recited in claim 1 wherein the moving means comprises:
a vessel for holding the shells suspended in the liquid, the vessel defining a first axis and having an open end and a closed end; and
a motor for rotating the vessel about the first axis in a first direction with an angular velocity +Ω, and for revolving the first axis about a second axis in a second direction with an angular velocity −Ω, wherein the first axis is substantially parallel to the second axis.

9. A device as recited in claim 8 wherein the vessel includes an interior wall extending between the open end and a point on the first axis at the closed end of the vessel, and wherein the interior wall is defined by a decreasing radius of curvature in a direction from the point at the closed end to the open end.

10. A device as recited in claim 9 further comprising a means for polymerizing each shell after the wall for the shell is established with a substantially uniform thickness.

11. A device for controlling the uniformity of wall thickness for a plurality of hollow spherical shells having central cores and suspended in a liquid which comprises:
a container for receiving the liquid and the shells suspended therein; and
a means for moving the container on a predetermined path to impose a variable angular acceleration on each shell, and to obviate the effects of gravity as the core in each shell is centered to establish a wall for the shell having a substantially uniform thickness.

12. A device as recited in claim 11 wherein movement of the container varies the magnitude of the angular velocity of the shells.

13. A device as recited in claim 11 wherein movement of the container varies the direction of the angular velocity of the shells.

14. A method for controlling the uniformity of wall thickness for a plurality of hollow spherical shells having central cores which comprises the steps of:
suspending each shell in a liquid; and
moving the liquid to impose a variable angular acceleration on each shell, and to obviate the effects of gravity as the core in each shell is centered to establish a wall for the shell having a substantially uniform thickness.

15. A method as recited in claim 14 wherein the moving step comprises:
introducing the liquid and a suspended shell therein into a lumen of a tube defining a longitudinal axis; and
selectively varying the angular velocity of the tube in rotation about the axis to impose the variable angular acceleration upon the liquid and upon the shells suspended therein.

16. A method as recited in claim 15 wherein during the selectively varying step the angular velocity of the tube is varied between an angular velocity Ω₁ and an angular velocity Ω₂, and wherein Ω₁ is greater than zero and less than Ω₂ (0<Ω₁<Ω₂).

17. A method as recited in claim 16 wherein the selectively varying step comprises the step of changing the direction of the angular acceleration within approximately every second.

18. A method as recited in claim 14 further comprising the step of polymerizing each shell at a predetermined region along the tube.

19. A method as recited in claim 14 wherein the moving step comprises the steps of:
introducing the liquid and the suspended shells therein to a vessel defining a first axis and having an open end and a closed end;
rotating the vessel about the first axis in a first direction with an angular velocity +Ω; and
revolving the first axis about a second axis in a second direction with an angular velocity −Ω to impose the variable angular acceleration upon shells suspended in the liquid, wherein the first axis is substantially parallel to the second axis.

20. A method as recited in claim 19 further comprising the step of polymerizing each shell after the wall for the shell is established with a substantially uniform thickness.
